(19) United States
(12) Patent Application Publication
(10) Pub. No.: US 2007/0242468 A1
(43) Pub. Date: Oct. 18, 2007

(54) Reconfigurable floor/desk lamp

(76) Inventor: James C.P. Leung, New Territories (CN)

Correspondence Address: ALIX YALE & RISTAS LLP, 750 MAIN STREET, SUITE 1400, HARTFORD, CT, 06103, US

(21) Appl. No.: 11/402,753

(22) Filed: Apr. 12, 2006

(51) Int. Cl. F21S 8/08

(52) U.S. Cl. 362/410

(57) ABSTRACT

A lamp includes a base, a light source, three or more articulated links, a first of which extends from the base and a last of which is pivotally secured to the light source. The links are reconfigurable between a floor lamp configuration in which the links are co-linear and the light source and base are maximally displaced from one another, and a desk/table lamp configuration in which the light source rests upon the base.

### BACKGROUND OF THE INVENTION

The present invention relates to lamps. More particularly, although not exclusively, the invention relates to a lamp that can be reconfigured between an upstanding floor lamp configurations and a folded desk or table lamp configuration.

Floor lamps are known to comprise a base from which a long vertical post extends to support a light source. The light source might be an incandescent globe or a fluorescent tube for example. The light source might be housed under a hood or shade which might be adjustable in angle.

Desk or table lamps are known to comprise a base from which an arm extends in pivotal matter to support a light source—usually a fluorescent tube or the like. Again, the light source might be housed under a hood or shade which might be adjustable in angle.

### OBJECTS OF THE INVENTION

It is an object of the present invention to provide a lamp that can be reconfigured between a floor lamp configuration on the one hand, and a desk or table lamp configuration on the other.

It is a further object of the present invention to provide such a lamp having a convenient carry handle by which the lamp can be grasped and carried in the desk/table lamp configuration.

### DISCLOSURE OF THE INVENTION

There is disclosed herein a lamp comprising:
a base,
a light source,
three or more articulated links, a first of which extends from the base and a last of which is pivotally secured to the light source, wherein the links are reconfigurable between a floor lamp configuration in which the links are substantially co-linear and the light source and base are maximally displaced from one another, and a desk/table lamp configuration in which the light source rests upon the base.

Preferably, a second of said links is connected to the first link and forms a handle by which lamp can be hand-carried in the desk/table lamp configuration.

Preferably, the light source is situated between the base and the second link in the desk/table lamp configuration.

Preferably, the second link comprises a handgrip.

Preferably, the light source comprises a fluorescent light housed within a light-diffusive housing.

Preferably, a battery to power the light source is located in the base.

### BRIEF DESCRIPTION OF THE DRAWINGS

A preferred form of the present invention will now be described by way of example with reference to the accompanying drawings, wherein:

FIG. 1 is a schematic perspective illustration of a lamp in an upstanding floor lamp configuration,

FIG. 2 is a schematic perspective illustration of the lamp of FIG. 1 being folded down from the floor lamp configuration, and

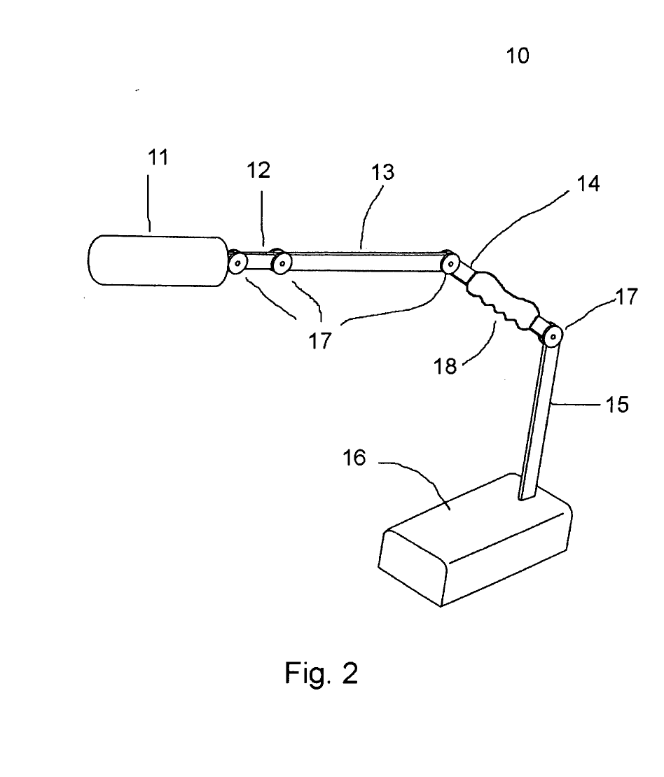

FIG. 3 is estimated perspective illustration of the lamp of FIGS. 1 and 2 in a folded down the desk/table lamp and carrying configuration.

### DESCRIPTION OF THE PREFERRED EMBODIMENT

In the accompanying drawings there is depicted schematically a lamp 10 having a light source 11 comprising a high-efficiency fluorescent lamp housed within a light-diffusive housing.

An articulated sequence of links 12, 13, 14 and 15 extend between the light source 11 and a heavy base 16. The bottom link 15 is firmly secured to the base 16 and extends therefrom at a right angle. Link 14 is pivotally secured to link 15. Link 13 is pivotally secured to link 14, and link 12 is pivotally secured to both the light source 11 and link 13. The pivotal connections are made by means of hinges 17 that are tight fitting to provide pivotal resistance.

A battery (not shown) would be located within the base and a switch (not shown) would be provided somewhere upon the lamp. A flexible lead (not shown) would extend from the base to the light source 11 via the switch.

There is a handgrip 18 moulded or otherwise formed upon the second link 14. The handgrip has four finger indentations.

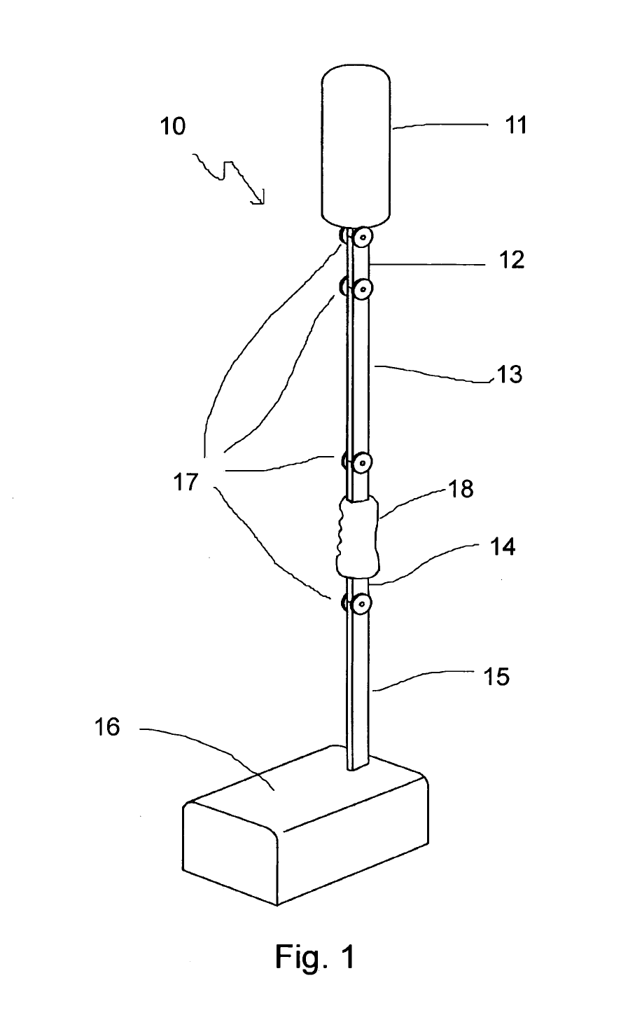

In the configuration of the lamp as depicted in FIG. 1, the links 12, 13, 14 and 15 are substantially co-linear and vertical so that the base can rest upon the floor—say alongside a lounge chair so that the light source can provide illumination from shoulder level or higher for example.

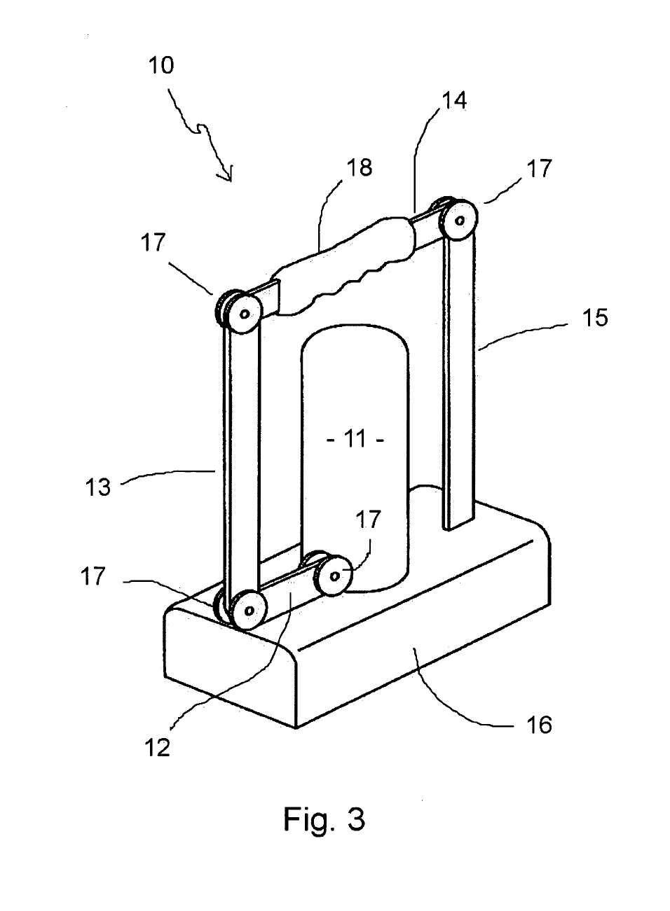

In the configuration of the lamp as depicted in FIG. 3, the links 12, 13, 14 and 15 form the sides of a rectangle together with the base 16. In this configuration, the second link 14 extends over the top of the light source 11 which itself rests directly upon the base 16. In this configuration, the handgrip 18 can be used to grasp the lamp for carrying purposes. As the hinges 17 are fairly tight, the configuration depicted in FIG. 3 will be retained during carrying.

It should be appreciated that modifications and alterations obvious to those skilled in the art are not to be considered as beyond the scope of the present invention. For example, there might be provided a locking mechanism at each hinge 17 to retain the links in any desired configuration. Furthermore, the battery might be housed in the diffusive housing of light source, and still furthermore, rather than being battery-powered, a mains power flex lead could extend from the light source 11 along or through the articulated linkages for connection to a wall outlet via a switch.

1. A lamp comprising:
a base,
a light source,
three or more articulated links, a first of which extend from the base and a last of which is pivotally secured to the light source, wherein the links are reconfigurable between a floor lamp configuration in which the links are substantially co-linear and the light source and base are maximally displaced from one another, and a desk/table lamp configuration in which the light source rests upon the base.

2. The lamp of claim 1, wherein a second of said links connected to the first link forms a handle by which lamp can be hand-carried in the desk/table lamp configuration.

3. The lamp of claim 2, wherein the light source is situated between the base and the second link in the desk/table lamp configuration.

4. The lamp of claim 2, wherein the second link comprises a handgrip.

5. The lamp of claim 1, wherein the light source comprises a fluorescent light housed within a light-diffusive housing.

6. The lamp of claim 1, further comprising a battery located in the base to power the light source.

7. A lamp comprising:
a base,
a light source,
four or more articulated links, a first of which extends from said base and the last of which is pivotally secured to said light source, wherein the links are configurable between a floor lamp configuration in which the links are substantially co-linear and the light source and base are maximally displaced from one another, and a desk/table lamp configuration in which the light source rests upon the base.

8. The lamp of claim 7, wherein one of said links forms a handle by which the lamp can be carried in the desk/table lamp configuration.

9. The lamp of claim 8, wherein said one of the said links is parallel to said base when in the desk/table lamp configuration.

10. The lamp of claim 8, wherein there are four links and said one of said links is connected to said first link forming a second link.

11. The lamp of claim 10, wherein said second link comprises a hand grip.

12. The lamp of claim 7, wherein said light source is situated between the base and said one of said links in the desk/table lamp configuration.

13. The lamp of claim 7, wherein there are four links, said links forming the sides of a rectangle together with said base in the desk/table lamp configuration.

14. The lamp of claim 7, wherein the light source comprises a fluorescent light housed in a light-diffusive housing.

15. The lamp of claim 7, further comprising a battery located in the base to power the light source.
